(19) United States
(12) Patent Application Publication
(10) Pub. No.: US 2015/0033042 A1
(43) Pub. Date: Jan. 29, 2015

(54) POWER SUPPLY SYSTEM, ELECTRONIC DEVICE, CABLE, AND PROGRAM

(71) Applicant: Funai Electric Co., Ltd., Osaka (JP)

(72) Inventor: Atsushi IWAMOTO, Daito-shi (JP)

(21) Appl. No.: 14/335,448

(22) Filed: Jul. 18, 2014

(30) Foreign Application Priority Data
Jul. 24, 2013 (JP) 2013-153416

(51) Int. Cl. G06F 1/26

(52) U.S. Cl. CPC G06F 1/266
USPC 713/310

(57) ABSTRACT

A power supply system includes an electronic device configured to output from an external audio output terminal a power-supply signal according to a target value for supply voltage when power is supplied to an external device and a cable with a rectifier circuit that rectifies the power-supply signal and generates the supply voltage.

### BACKGROUND OF THE INVENTION

1. Field of the Invention

The present invention relates to a power supply system and also to an electronic device, a cable, and a program used in this power supply system.

2. Description of the Related Art

Electronic devices (such as smartphones and personal computers) configured to supply power to external devices using universal serial bus (USB) terminals (so-called USB power supply functionality) have been used in the past.

Japanese Patent Application Laid-Open Publication No. 2001-005580 discloses a connector device equipped with a headphone terminal, a bidirectional serial signal terminal, and a power switch signal terminal.

Japanese Patent Application Laid-Open Publication No. 2005-044207 discloses a mobile information device in which the power required to run a display unit and control circuitry is supplied from a power supply unit through a power connection cable, and also in which the voltage from the power supply unit is monitored by a power supply monitoring circuit installed in the control circuitry, and the status thereof is displayed on the display unit.

Japanese Patent Application Laid-Open Publication No. 2012-138274 discloses cables for determining whether a first cable is connected to an electronic device and a second cable is also connected to this electronic device.

With conventional electronic devices, however, the voltage supplied to external devices that use USB terminals is set at 5 V (±10%). For this reason, when the drive voltage of an external device is lower than this, a separate voltage converter (for example, converting from 5 V to 3 V) is required, raising the issue of complexity in the configurations of external devices (and even the overall system that includes the external device).

### SUMMARY OF THE INVENTION

Preferred embodiments of the present invention provide a power supply system that freely adjusts a voltage supplied from electronic devices to external devices, and also provide an electronic device, a cable, and a program used in the power supply system.

A power supply system according to a preferred embodiment of the present invention includes an electronic device configured to output from an external audio output terminal a power-supply signal according to a target value for supply voltage when power is supplied to an external device and a cable with a rectifier circuit that is configured to rectify the power-supply signal and generate the supply voltage. With this configuration, it is possible to build a power supply system which freely adjusts the supply voltage from electronic devices to external devices.

The electronic device preferably is configured to output sine wave signals on two channels of different phases as the power-supply signals, and the rectifier circuit is configured to double the voltage, through rectification, of each of the two channels of power-supply signals and combine them to generate the supply voltage. Thus, the voltage supplied to external devices is increased.

The electronic device preferably is configured to output sine wave signals on two channels as the power-supply signals, and the rectifier circuit is configured to double the voltage, through rectification, of each of the two channels of power-supply signals to generate two circuits of supply voltages in parallel. Thus, power is supplied to two circuits of external devices in parallel.

The electronic device preferably gradually raises the amplitude of the power-supply signal(s), and when the electronic device detects a start confirmation signal that is input at the external audio input terminal over the cable from the external device, the electronic device halts the increase in the amplitude of the power-supply signal(s) and sets the amplitude of the power-supply signal(s). Thus, a supply voltage appropriate for an external device is adjusted automatically.

The electronic device preferably is configured to adjust the amplitude of the power-supply signal(s) such that the supply voltage fed back to the external audio input terminal over the cable from the rectifier circuit matches a target value. Thus, the voltage supplied to an external device is matched to a target value with good precision.

An electronic device according to a preferred embodiment of the present invention preferably includes an external audio output terminal and a controller configured and programmed to control switching between an external audio output mode which outputs an audio signal from the external audio output terminal and an external power supply mode which outputs a power-supply signal from the external audio output terminal. If an electronic device according to this preferred embodiment of the present invention is used with a cable provided with a rectifier circuit, it is possible to build a power supply system which freely adjusts the supply voltage from the electronic device to the external device.

Moreover, the cable according to a preferred embodiment of the present invention includes a first connector that is connected to or disconnected from the external audio output terminal of an electronic device which constitutes the power-supplying side, a second connector that is connected to or disconnected from the power supply terminal of an external device which constitutes the power-receiving side, and a rectifier circuit configured to generate a supply voltage to the external device by rectifying a power-supply signal that is output from the external audio output terminal of the electronic device. If a cable according to this preferred embodiment of the present invention is used with an electronic device that has a power supply signal output function, it is possible to build a power supply system that freely adjusts the supply voltage from the electronic device to the external device.

In addition, according to another preferred embodiment of the present invention, a non-transitory computer-readable medium includes a program for performing, when the program runs on a controller of an electronic device including an external audio output terminal in order to supply power from the electronic device to an external device over a cable with a rectifier circuit, a method including switching between an external audio output mode and an external power supply mode, controlling signal output from the external audio output terminal such that an audio signal is output according to audio data when in the external audio output mode, and controlling signal output from the external audio output terminal such that a power-supply signal is output according to a target value for supply voltage to the external device when in the external power supply mode. Thus, an external power supply function uses the external audio output terminal of an existing electronic device without changing the hardware configuration whatsoever.

Various preferred embodiments of the present invention make it possible to provide a power supply system that freely adjusts voltage supplied from electronic devices to external devices, and also an electronic device, a cable, and a program used such a power supply system.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a block diagram showing a power supply system according to a first preferred embodiment of the present invention.

FIG. 2 is an external view showing the power supply system according to the first preferred embodiment of the present invention.

FIG. 3 is a circuit diagram showing a first configuration example of the voltage-doubler rectifier circuit.

FIG. 4 constitutes waveform diagrams for illustrating the voltage-doubling rectification action.

FIG. 5 constitutes external views showing GUI screens while running external power supply programs.

FIG. 6 is a block diagram showing a power supply system according to a second preferred embodiment of the present invention.

FIG. 7 is an external view showing the power supply system according to the second preferred embodiment of the present invention.

FIG. 8 is a circuit diagram showing a second configuration example of the voltage-doubler rectifier circuit.

FIG. 9 is a block diagram showing a power supply system according to a third preferred embodiment of the present invention.

FIG. 10 is a flowchart for illustrating the operation for fully automated setting of the supply voltage.

FIG. 11 is a block diagram showing a power supply system according to a fourth preferred embodiment of the present invention.

FIG. 12 is a circuit diagram showing a third configuration example of the voltage-doubler rectifier circuit.

### DETAILED DESCRIPTION OF THE PREFERRED EMBODIMENTS

### First Preferred Embodiment

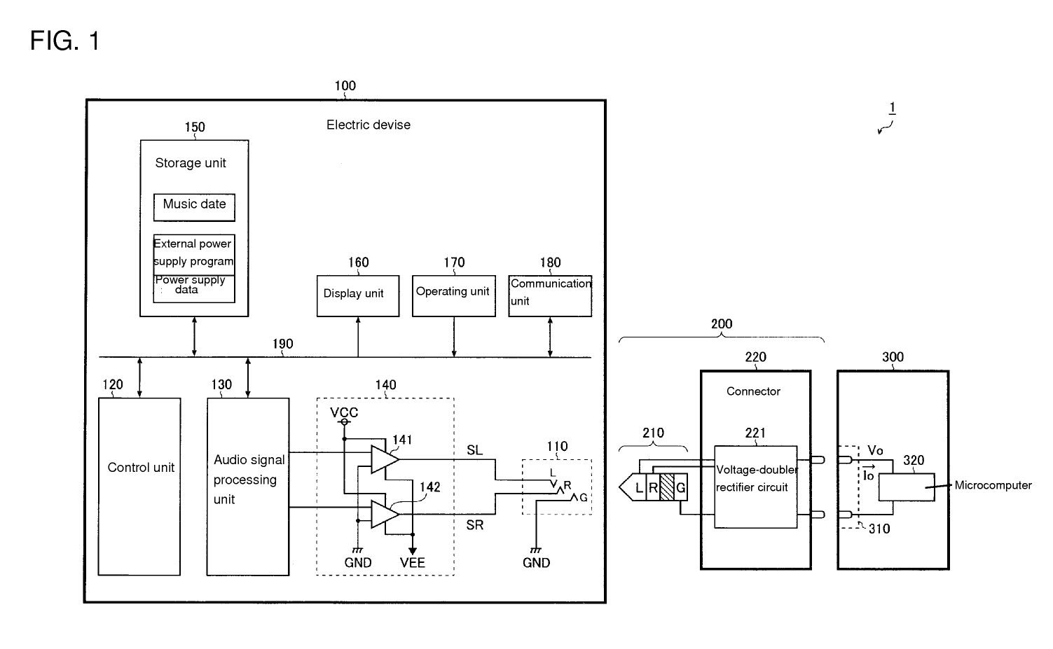

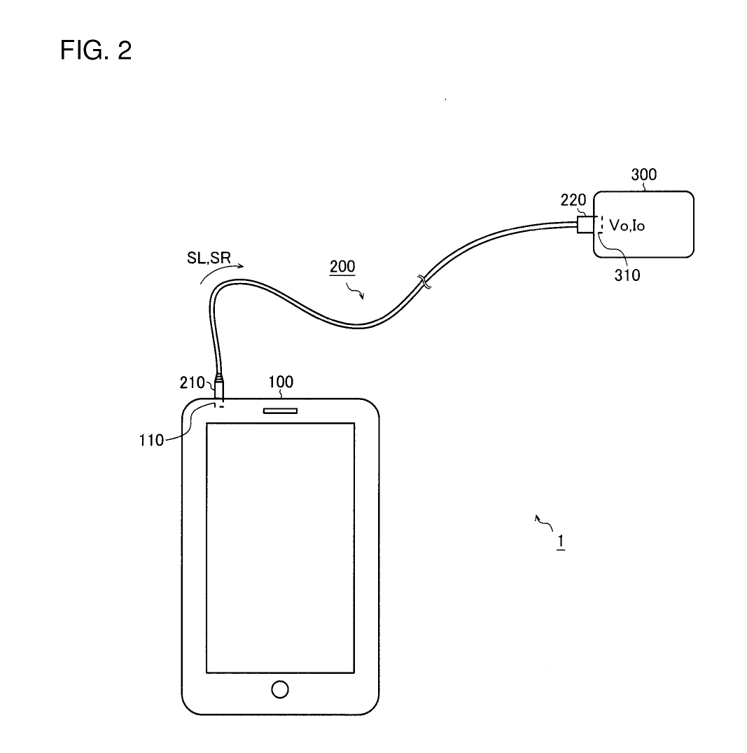

FIG. 1 and FIG. 2 are, respectively, a block diagram and an external view showing a power supply system according to a first preferred embodiment of the present invention. The power supply system 1 of the first preferred embodiment supplies power from the external audio output terminal 110 of an electronic device 100 to an external device 300 via a cable 200 with a rectifier circuit 221.

The electronic device 100 that constitutes the power-supplying side preferably includes the external audio output terminal 110, a controller 120, an audio signal processing unit 130, an output drive unit 140, a storage unit 150, a display unit 160, an operating unit 170, a communication unit 180, and a bus 190. Note that a smartphone (mobile phone) is shown in FIG. 2 as an example of the electronic device 100, but it can be replaced with other electronic devices equipped with an external audio output terminal (such as tablet terminals, notebook computers, and portable game units, for example).

The external audio output terminal 110 preferably is a 3-pole headphone jack to which or from which a 3-pole headphone plug (or 2-pole headphone plug) is connected or disconnected; it includes an L-pole terminal for a left channel, an R-pole terminal for a right channel, and a G-pole terminal for a ground. The external audio output terminal 110 is configured to output audio signals to external speakers such as stereo headphones. In the power supply system 1 of the first preferred embodiment, this external audio output terminal 110 is also used as a terminal to supply power to the external device 300.

The controller 120 is configured and programmed to control the actions and operation of the electronic device 100. In particular, for the implementation of an external power supply functionality that uses the external audio output terminal 110, the controller 120 is configured and programmed to switch between an external audio output mode that outputs an audio signal from the external audio output terminal 110 and an external power supply mode that outputs power-supply signals SL and SR from the external audio output terminal 110. To put it in more concrete terms, by running an external power supply program stored in the storage unit 150 according to user operations received over the operating unit 170, the controller 120 is configured and programmed to define a switching device between an external audio output mode and an external power supply mode, a controller configured to control signal output from the external audio output terminal 110 such that an audio signal is output in keeping with music data when in the external audio output mode, and a controller configured to control signal output from the external audio output terminal 110 such that power-supply signals SL and SR are output in keeping with a target value for voltage Vo supplied to the external device 300 when in the external power supply mode.

The audio signal processing unit 130 respectively generates two channels of drive signals according to the music data or power supply data read from the storage unit 150 and sends them to the output drive unit 140.

The output drive unit 140 includes drivers 141 and 142 that operate when they are supplied with a positive power supply voltage VCC (e.g., about +1.5 V) and a negative power supply voltage VEE (e.g., about −1.5 V) and drives the external audio output terminal 110 according to the two channels of drive signals that are input from the audio signal processing unit 130. Note that voltage signals whose voltage values fluctuate between positive and negative (audio signals or power-supply signals SL and SR) are applied respectively to the L-pole terminal and R-pole terminal of the external audio output terminal 110 with the ground voltage GND (0 V) serving as a reference.

The storage unit 150 provides nonvolatile storage of a variety of programs that are read and run by the controller 120 and a variety of data used when running these programs. For implementing external power supply functionality that uses the external audio output terminal 110, in particular, the external power supply program and power supply data (sine wave data of a specified frequency) are stored in the storage unit 150.

The display unit 160 provides screen displays based on instructions from the controller 120. A liquid crystal display, organic EL (electroluminescent) display, or the like is suitable for use as the display unit 160.

The operating unit 170 includes buttons, switches, touch panel, keyboard, and the like and accepts user operations.

The communication unit 180 conducts wired or wireless communications between external terminals and a base station. If the configuration has a communication unit 180, external power supply programs and power supply data can be downloaded and installed from an external server without needing to pre-install them on the electronic device 100.

The bus 190 is a signal transfer path that links circuit blocks within the electronic device 100 and includes an address bus, data bus, control lines, and the like. However, FIG. 1 shows only an example, and circuit blocks may also be optionally connected directly without going through a bus 190.

The cable 200 is a conductive pathway for wired connection between the electronic device 100 and the external device 300 when power is supplied from the electronic device 100 to the external device 300, and it includes a first connector 210, a second connector 220, and a voltage-doubler rectifier circuit 221. The length of the cable 200 can be selected freely according to its application in a range anywhere from several tens of centimeters to several meters.

The first connector 210 is a 3-pole headphone plug that is connected to or disconnected from the external audio output terminal 110 of the electronic device 100; it includes an L-pole terminal for a left channel, an R-pole terminal for a right channel, and a G-pole terminal for a ground. Note that the individual pole terminals are insulated from each other.

The second connector 220 is a terminal that is connected to or disconnected from the power supply terminal 310 of the external device 300; it internally incorporates the voltage-doubler rectifier circuit 221. However, the voltage-doubler rectifier circuit 221 may also be installed separate from the second connector 220.

The voltage-doubler rectifier circuit 221 is configured to generate the supply voltage Vo to the external device 300 by doubling the voltage, through rectification, of the power-supply signals SL and SR that are output from the external audio output terminal 110 of the electronic device 100. The circuit configuration and operation of the voltage-doubler rectifier circuit 221 will be described later.

The external device 300 that constitutes the power-receiving side includes the power supply terminal 310 that is connected to or disconnected from the second connector 220 of the cable 200 and a load 320 (such as a microcomputer) that operates on the supply voltage Vo applied to the power supply terminal 310. Low current-consuming remote controllers and wireless headsets are non-limiting examples of such external devices 300.

With the power supply system 1 having such a configuration, the external device 300 is capable of being used continuously by supplying power externally from the electronic device 100, even when, for example, its battery runs out during outdoor use of the external device 300.

A non-limiting example of an operating method is as follows. First, the cable 200 is used to connect the external audio output terminal 110 of the electronic device 100 to the power supply terminal 310 of the external device 300. Next, supply signals SL and SR matched to target values for the supply voltage Vo are output from the external audio output terminal 110 by running the external power supply program on the electronic device 100. By such a series of tasks, the supply voltage Vo is generated by doubling the voltage through rectification of the supply signals SL and SR in the voltage-doubler rectifier circuit 221 installed in the cable 200, so the external device 300 operates with the input of the supply voltage Vo.

The power supply system 1 of the first preferred embodiment, in particular, outputs the supply voltage Vo that is optimal to drive the external device 300 by controlling the supply signals SL and SR using the external power supply program. For example, a 1.5-V supply voltage Vo can be output to the external device 300 that is driven by a single battery (1.5 V), and a 3.0-V supply voltage Vo can be output to an external device 300 that is driven by two batteries (3.0 V). Variable control of the supply voltage Vo will be described in detail below, along with the configuration and operation of the voltage-doubler rectifier circuit 221.

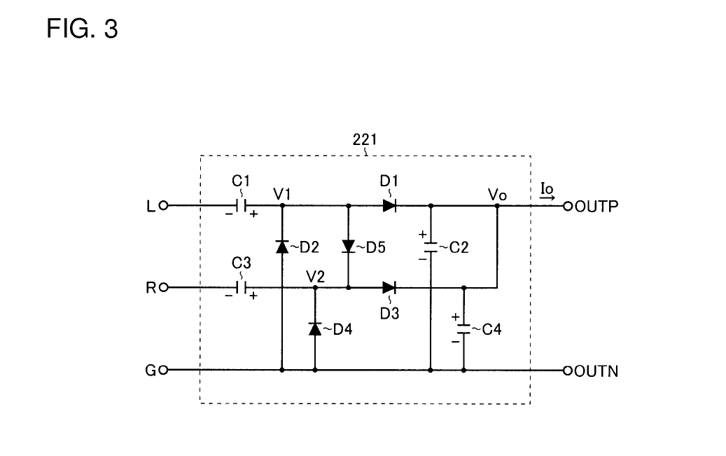

FIG. 3 is a circuit diagram showing a first configuration example of the voltage-doubler rectifier circuit 221. The voltage-doubler rectifier circuit 221 of the first configuration example includes capacitors C1 to C4 and diodes D1 to D5.

The first end of the capacitor C1 is connected to the input terminal L (the L-pole terminal of the first connector 210). The second end of the capacitor C1 (the end where the node voltage V1 is applied) is connected to the anode of the diode D1 and the cathode of the diode D2. The cathode of the diode D1 and the first end of the capacitor C2 are both connected to the positive output terminal OUTP (the end where the supply voltage Vo is applied). The anode of the diode D2 and the second end of the capacitor C2 are both connected to the ground terminal G and the negative output terminal OUTN.

The first end of the capacitor C3 is connected to the input terminal R (the R-pole terminal of the first connector 210). The second end of the capacitor C3 (the end where the node voltage V2 is applied) is connected to the anode of the diode D3 and the cathode of the diode D4. The cathode of the diode D3 and the first end of the capacitor C4 are both connected to the positive output terminal OUTP (the end where the supply voltage Vo is applied). The anode of the diode D4 and the second end of the capacitor C4 are both connected to the ground terminal G and the negative output terminal OUTN.

The anode of the diode D5 is connected to the second end of the capacitor C1. The cathode of the diode D5 is connected to the second end of the capacitor C2.

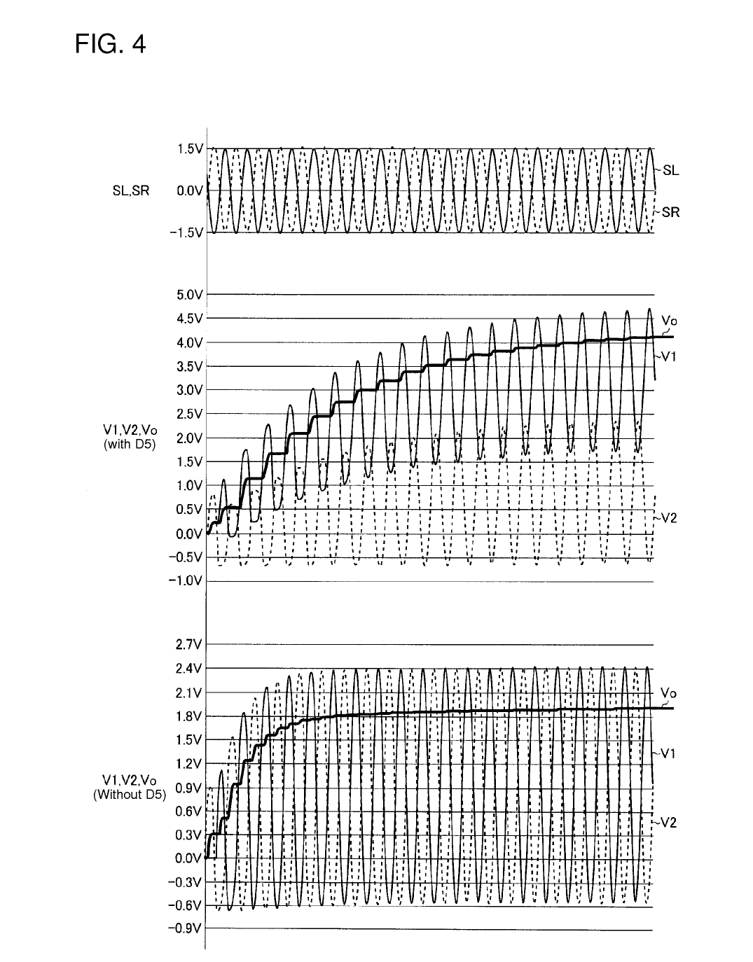

FIG. 4 constitutes waveform diagrams for illustrating the voltage-doubling rectification action, plotting, in order from the top, the supply signals SL and SR, the individual voltage behaviors when there is a diode D5 (V1, V2, and Vo), and the individual voltage behaviors when there is no diode D5 (V1, V2, and Vo).

The supply signals SL and SR are sine wave signals, each of which has a specified frequency (for example, 20 kHz or higher); they preferably have amplitudes of ±1.5 V, using the ground voltage GND (0 V) as the reference, for example. Furthermore, the supply signals SL and SR preferably are shifted in phase from each other by 180°, for example

The basic voltage-doubling rectification action will be described first focusing solely on the supply signal SL. When the supply signal SL is a negative potential, the input terminal L is a lower potential than the ground terminal G, so the diode D2 is forward biased, and the capacitor C1 is charged at the polarity shown in the figure. At this time, the diode D1 becomes reverse biased, so there is no reverse flow of current from the positive output terminal OUTP toward the capacitor C1.

Thereafter, when the supply signal SL becomes a positive potential, the diode D2 becomes reverse biased, and the charging pathway of the capacitor C1 through the diode D2 is shut off. At this time, the node voltage V1 is increased by the principle of conservation of charge of the capacitor C1 to a potential that is higher than the supply signal SL by the amount of the voltage between the two ends of the capacitor C1 (charging voltage). As a result, the diode D1 becomes forward biased, and the capacitor C2 is charged at the polarity shown in the figure.

As a result of the periodic repetition of the action, a positive voltage that doubles the voltage by rectifying the supply signal SL (approximately +1.8 V if attention is focused only on the voltage-doubling rectification action of the supply signal SL) appears at the first end of the capacitor C2 (the high potential end). Note that for the supply signal SR as well, a voltage-doubling rectification action similar to that described above is executed in parallel by using the capacitors C3 and C4 and the diodes D3 and D4.

Here, the electronic device 100 is configured to output sine wave signals whose phases are offset by 180° from each other as supply signals SL and SR, and the voltage-doubler rectifier circuit 221 is configured to include the diode D5 connected between the capacitor C1 and the capacitor C3 with the polarity shown in the figure while also having both of the first ends of the capacitors C2 and C4 (the high potential ends) connected to the positive output terminal OUTP.

By adopting such a configuration, the node voltage V1 is made to fluctuate periodically while maintaining a higher potential than the node voltage V2. As a result, the voltage-doubler rectifier circuit 221 generates the final supply voltage Vo (for example, approximately +4.0 V) by combining the positive voltages obtained by respectively doubling the voltage by rectifying the supply signals SL and SR (see the middle level of FIG. 4).

Moreover, if the configuration is such that the supply voltage Vo for a single circuit is generated from the two channels of power-supply signals SL and SR, the total current for two channels is supplied as the supply current Io to the external device 300, so a load 320 that has a relatively large current consumption is also driven.

Note that when the voltage-doubler rectifier circuit 221 does not include the diode D5, the supply voltage Vo ultimately obtained no longer changes from the positive voltage (e.g., preferably approximately +1.8 V) obtained by doubling the voltage, through rectification, of each of the supply signals SL and SR, so it becomes less meaningful to run voltage-doubling rectification in parallel on the two channels of supply signals SL and SR (see the bottom level of FIG. 4). Depending on the power supply specifications of the external device 300, however, it may be possible to omit the diode D5. For example, although the total current of two channels is required for the supply current Io, when supplying power to the external device 300 satisfied by a supply voltage Vo that is about +1.8 V or less, the diode D5 may be omitted.

In addition, the voltage-doubler rectifier circuit 221 is configured to increase the voltage-doubling capacity (boosting magnification) by stacking pairs of capacitors and diodes in multiple levels serially. However, because output current decreases as the number of stack levels is increased, it is preferable to design the number of stack levels appropriately for the power supply specifications of the external device 300.

Furthermore, depending on the power supply specifications of the external device 300, it is also possible to use a full-wave rectifier circuit such as a diode bridge instead of the voltage-doubler rectifier circuit 221. In this case, however, because the supply voltage Vo will be about +1.5 V or less, it should be noted that the selections for the external device 300 that can be supplied with power will be more limited.

As it happens, the voltage value of the supply voltage Vo generated by the voltage-doubler rectifier circuit 221 is freely adjusted according to the amplitude of the supply signals SL and SR. To put it in more concrete terms, the higher the setting for the amplitude of the supply signals SL and SR, the higher the supply voltage Vo; conversely, the lower the setting for the amplitude of the supply signals SL and SR, the lower the supply voltage Vo. Accordingly, it is important to appropriately control the amplitude of the supply signals SL and SR according to the power supply specifications of the external device 300.

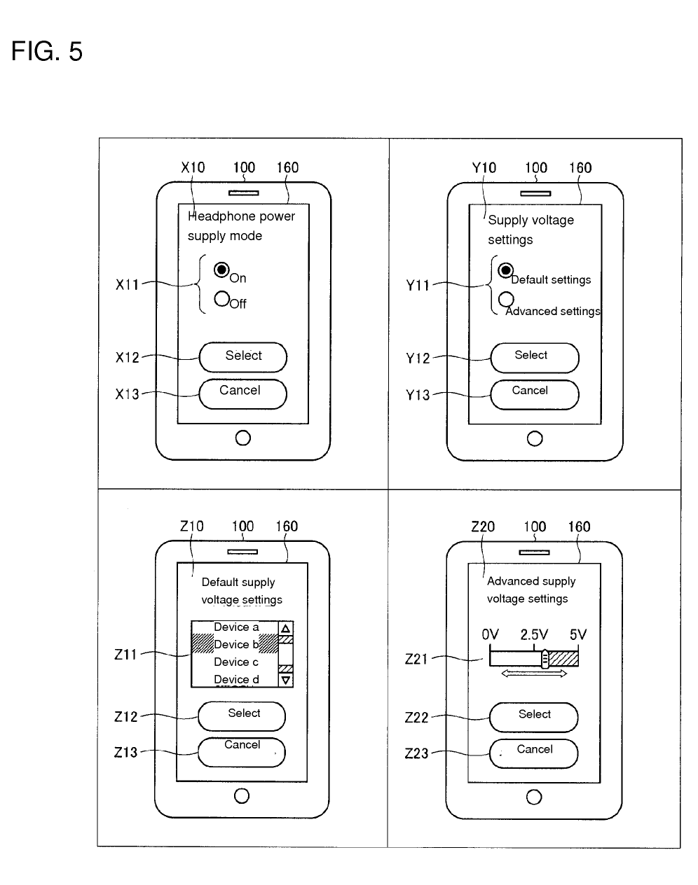

FIG. 5 constitutes external views showing graphical user interface (GUI) screens while running external power supply programs. When the external power supply program is run, a GUI screen X10 configured to switch the mode that supplies power externally using the external audio output terminal 110 (which is referred to here as “headphone power supply mode”) on and off is first displayed on the display unit 160 (see the upper-left section of FIG. 5). The GUI screen X10 includes radio buttons X11 configured to accept an on/off switching operation, a Select button X12 configured to accept an operation to determine the selection, and a Cancel button X13 configured to accept an operation to cancel the selection. When the headphone power supply mode is to be turned on, all that is necessary is to select “On” with the radio buttons X11 and then to tap the Select button X12; conversely, when the headphone power supply mode is to be turned off, all that is necessary is to select “Off” with the radio buttons X11 and then to tap the Select button X12. Note that if the Cancel button X13 is tapped, the external power supply program will terminate without reflecting the selection on the radio buttons X11 in the operation of the electronic device 100.

When On is selected for the headphone power supply mode on the GUI screen X10, a GUI screen Y10 configured to switch the setting method for the supply voltage Vo is displayed on the display unit 160 (see the upper-right section of FIG. 5). The GUI screen Y10 includes radio buttons Y11 configured to accept an operation to switch the supply voltage selection method, a Select button Y12 configured to accept an operation to determine the selection, and a Cancel button Y13 configured to accept an operation to cancel the selection. When it is desired to set the supply voltage Vo in a simple manner (automatic setting), all that is necessary is to select “Default settings” with the radio buttons Y11 and then to tap the Select button Y12; when it is desired to set the supply voltage Vo in a detailed manner (manual setting), all that is necessary is to select “Advanced settings” with the radio buttons Y11 and then to tap the Select button Y12. Note that if the Cancel button Y13 is tapped, the selection on the radio buttons Y11 is discarded, after which the display returns to the GUI screen X10.

When Default settings (automatic setting) is selected on the GUI screen Y10, a GUI screen Z10 configured to select the external device 300 to be supplied with power (hereinafter called the “device to be powered” for convenience of explanation) is displayed on the display unit 160 (see the lower-left section of FIG. 5). The GUI screen Z10 includes a list box Z11 configured to accept an operation to select the device to be powered, a Select button Z12 configured to accept an operation to determine the selection, and a Cancel button Z13 configured to accept an operation to cancel the selection. If the desired device to be powered (name, model number, etc.) is listed in the list box Z11, all that is necessary is to select this device to be powered (“Device b” in the example of FIG. 5) and then to tap the Select button Y12. Meanwhile, if the Cancel button Z13 is tapped, the selection on the list box Z11 is discarded, after which the display returns to the GUI screen Y10. Consequently, if the desired device to be powered is not listed in the list box Z11, for example, it is only necessary to tap the Cancel button Z13 to return to the GUI screen Y10 so as to go to Advanced settings (manual setting) of the supply voltage Vo.

When a device to be powered is selected on the GUI screen Z10, the controller 120 checks the target value for supply voltage Vo, which has been given an unambiguous correspondence with the selected device to be powered in advance, and controls the external audio output terminal 110 such that the amplitude of the power-supply signals SL and SR is controlled according to this target value. By using such a default setting (automatic setting), the target value for the optimal supply voltage Vo is set automatically by simply selecting the name or model number of the device to be powered, so a highly convenient external power supply function is realized. Note that for the correspondence between devices to be powered and supply voltage target values, a data table of an unambiguous correspondence between the two may be stored in the storage unit 150, and this may be referenced as needed. Moreover, if the data table is configured so as to be updatable at any time over the communication unit 180, it is possible to add afterward devices to be powered for which the supply voltage Vo can be easily set, thus making it possible to contribute to a further increase in convenience.

On the other hand, when Advanced settings is selected on the GUI screen Y10, a GUI screen Z20 configured to manually set the supply voltage Vo is displayed on the display unit 160 (see the lower-right section of FIG. 5). The GUI screen Z20 includes a slider Z21 configured to accept an operation to manually set the supply voltage Vo, a Select button Z22 configured to accept an operation to determine the setting, and a Cancel button Z23 configured to accept an operation to cancel the setting. When the target value for an appropriate supply voltage Vo is known, all that is necessary is to set this voltage value with the slider Z21 and then to tap the Select button Z22. If the Cancel button Z23 is tapped, however, the setting on the slider Z21 is discarded, after which the display returns to the GUI screen Y10. Consequently, if the target value for an appropriate supply voltage Vo is not known, for example, the Cancel button Z23 may be tapped to return to the GUI screen Y10 so as to go to Default settings (automatic setting) of the supply voltage Vo.

When a target value for supply voltage Vo is set on the GUI screen Z20, the controller 120 controls the external audio output terminal 110 such that the amplitude of the power-supply signals SL and SR is controlled according to this target value. With this type of advanced setting (manual setting), appropriate external power is supplied to devices to be powered that are not listed in the list box Z11 above, so it is possible to realize an external power supply function that is very generally and widely applicable.

Note that, with regard to the method for controlling the amplitude of the power-supply signals SL and SR, a conceivable method is to control the application volume that is set by the external power supply program to be freely variable after temporarily fixing the master volume set in the operating system (OS) of the electronic device 100 to its maximum value. This is the same as the control method for sound volume adjustment when outputting audio signals as dictated by music data when in external audio output mode. By using this sort of technique, the supply voltage Vo is capable of being freely adjusted using the existing sound volume adjustment function.

As was described above, the power supply system 1 of the first preferred embodiment preferably includes the electronic device 100 that outputs the power-supply signals SL and SR from the external audio output terminal 110 according to a target value for the supply voltage Vo when power is supplied to the external device 300 and the cable 200 with the rectifier circuit 221 that rectifies the power-supply signals SL and SR and generates the supply voltage Vo. By using this configuration, it is possible to build a power supply system 1 which allows the voltage Vo supplied from the electronic device 100 to the external device 300 to be freely adjusted.

Note that in the power supply system of the first preferred embodiment, the electronic device 100 preferably is configured to output sine wave signals on two channels of different phases as the power-supply signals SL and SR, and the rectifier circuit 221 doubles the voltage, through rectification, of each of the two channels of power-supply signals and combines them to generate the supply voltage Vo. By adopting such a configuration, the voltage Vo supplied to the external device 300 is significantly increased.

In addition, the electronic device 100 of the first preferred embodiment preferably includes the external audio output terminal 110 and the controller 120 that is configured to control switching between an external audio output mode (which outputs an audio signal from the external audio output terminal 110) and an external power supply mode (which outputs power-supply signals SL and SR from the external audio output terminal 110). By using the electronic device 100 of this configuration with the cable 200 that has the rectifier circuit 221, it is possible to build a power supply system 1 which freely adjusts the voltage Vo supplied from the electronic device 100 to the external device 300.

Furthermore, the cable 200 of the first preferred embodiment preferably includes the first connector 210 that is connected to or disconnected from the external audio output terminal 110 of the electronic device 100 constituting the power-supplying side, the second connector 220 that is connected to or disconnected from the power supply terminal 310 of the external device 300 constituting the power-receiving side, and the rectifier circuit 221 that generates the supply voltage Vo to the external device 300 by rectifying the power-supply signals SL and SR that are output from the external audio output terminal 110 of the electronic device 100. By using the cable 200 of this configuration with the electronic device 100 that has a power supply signal output function, it is possible to provide a power supply system which allows the voltage Vo supplied from the electronic device 100 to the external device 300 to be freely adjusted.

Moreover, the external power supply program of the first preferred embodiment is a program run on the controller 120 of the electronic device 100 for the purpose of supplying power to the external device 300 over the cable 200 with the rectifier circuit 221 from the electronic device 100 that has the external audio output terminal 110, and it causes the controller 120 function as a switching device configured to switch between an external audio output mode and an external power supply mode, a controller configured to control signal output from the external audio output terminal 110 such that an audio signal is output according to music data when in the external audio output mode, and a controller configured to control signal output from the external audio output terminal 110 such that power-supply signals SL and SR are output in accordance with the target value for supply voltage Vo to the external device 300 when in the external power supply mode. By installing this sort of program in the electronic device 100, it is possible to provide an external power supply function that uses the external audio output terminal 110 of the existing electronic device 100 without changing the hardware configuration whatsoever.

### Second Preferred Embodiment

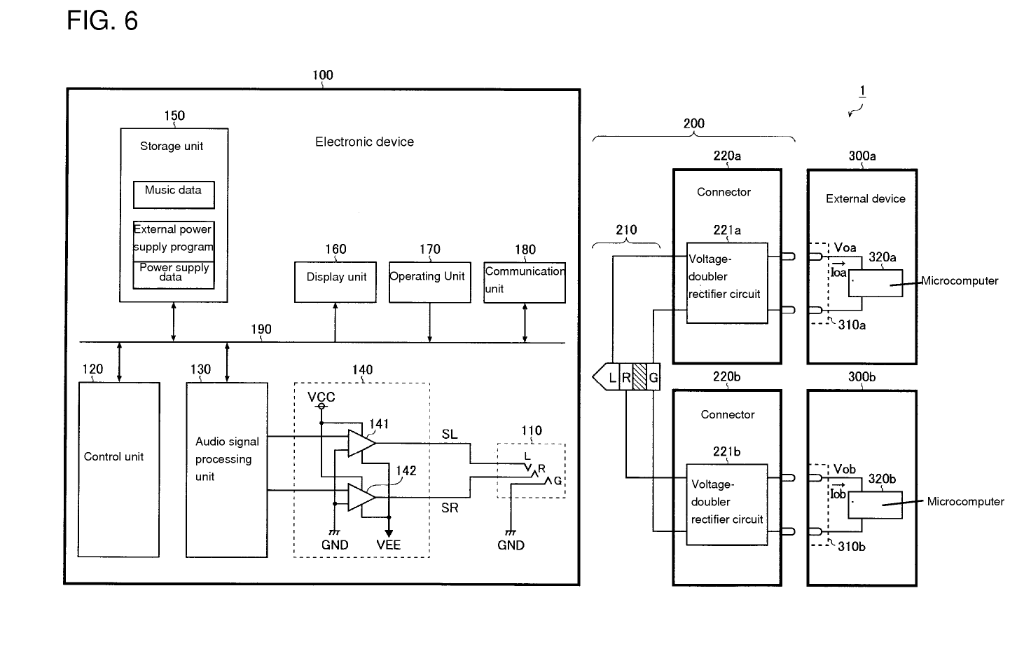

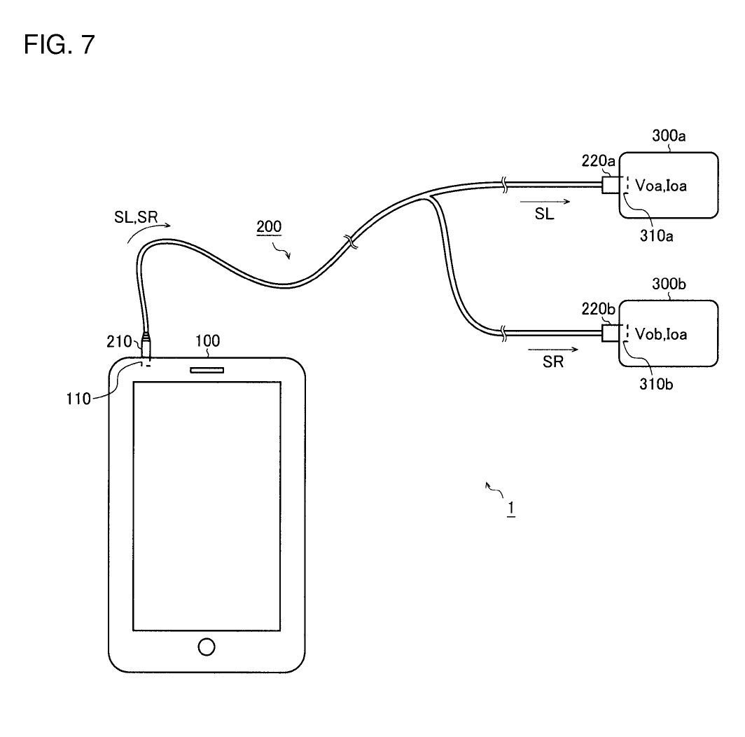

FIGS. 6 and 7 are, respectively, a block diagram and an external view showing a power supply system according to a second preferred embodiment of the present invention. The power supply system 1 of the second preferred embodiment basically has the same configuration as in the first preferred embodiment and is configured to generate supply voltages Voa and Vob for two circuits in parallel from two channels of power-supply signals SL and SR. Therefore, constituent elements that are the same as in the first preferred embodiment will be given the same symbols as in FIGS. 1 and 2, and redundant descriptions will be omitted. A description will be given below focusing only on portions that are characteristic of the second preferred embodiment.

In the power supply system 1 of the second preferred embodiment, the cable 200 has a structure that branches from a first connector 210 to two-circuit second connectors 220a and 220b. To put it in more concrete terms, the L-pole terminal and G-pole terminal of the first connector 210 are electrically connected to the second connector 220a, and the R-pole terminal and G-pole terminal of the first connector 210 are electrically connected to the second connector 220b.

Note that the second connector 220a is configured to be connected to or disconnected from the power supply terminal 310a of an external device 300a, and the second connector 220b is configured to be connected to or disconnected from the power supply terminal 310b of an external device 300b. In addition, voltage-doubler rectifier circuits 221a and 221b are respectively built into the second connectors 220a and 220b.

The voltage-doubler rectifier circuit 221a generates a supply voltage Voa and a supply current Ioa by doubling the voltage by rectifying the power-supply signal SL and outputs these to load 320a of the external device 300a, while the voltage-doubler rectifier circuit 221b generates a supply voltage Vob and a supply current Iob by doubling the voltage by rectifying the power-supply signal SR and outputs these to load 320b of the external device 300b.

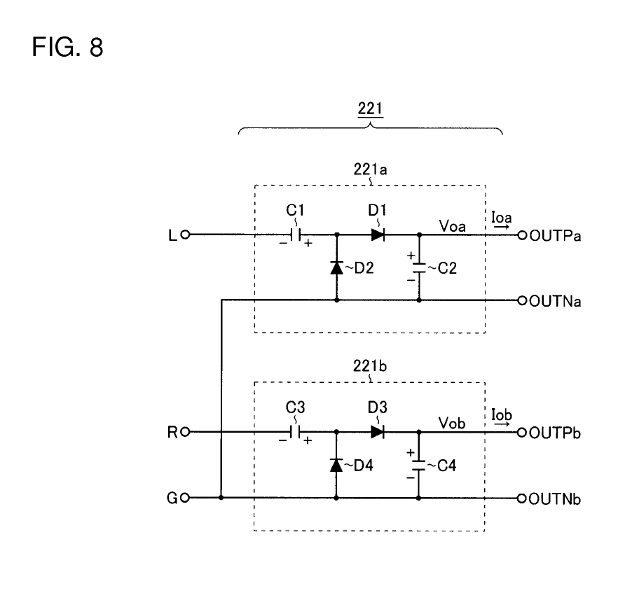

FIG. 8 is a circuit diagram showing a second configuration example of the voltage-doubler rectifier circuit 221. The voltage-doubler rectifier circuit 221 of the second configuration example has a configuration that branches the first configuration example (see FIG. 3) into two-circuit voltage-doubler rectifier circuits 221a and 221b (a configuration in which the first ends of the capacitors C2 and C4 are not connected to each other but are respectively connected to the positive output terminals OUTPa and OUTPb); it can output the charging voltages (approximately +1.8 V) of the capacitors C2 and C4 as supply voltages Voa and Vob, respectively, in parallel. In this case, if the amplitudes of the power-supply signals SL and SR are individually adjusted, the supply voltages Voa and Vob are capable of being variably controlled independently from each other.

However, in the voltage-doubler rectifier circuit 221 of the second configuration example that generates, in parallel, the two circuits of supply voltages Voa and Vob from the two channels of power-supply signals SL and SR, the supply voltages Voa and Vob and the supply currents Ioa and Iob are lower compared to the first configuration example described above, so due consideration should be given to the fact that the supply capacity of each circuit will be lower.

Note that the diode D5 of the first configuration example is omitted in the voltage-doubler rectifier circuit 221 of the second configuration example, but when it is desired to further increase the supply voltage Voa, a diode D5 may also be inserted between the capacitor C1 and the capacitor C3, just as in the first configuration example.

Note that in the power supply system 1 of the second preferred embodiment, as was described above, the electronic device 100 preferably is configured to output sine wave signals on two channels as the power-supply signals SL and SR, and the rectifier circuit 221 doubles the voltage, through rectification, of the two channels of power-supply signals SL and SR individually to generate the supply voltages Voa and Vob for two circuits in parallel. By adopting such a configuration, power is supplied to two circuits of the external devices 300a and 300b in parallel.

### Third Preferred Embodiment

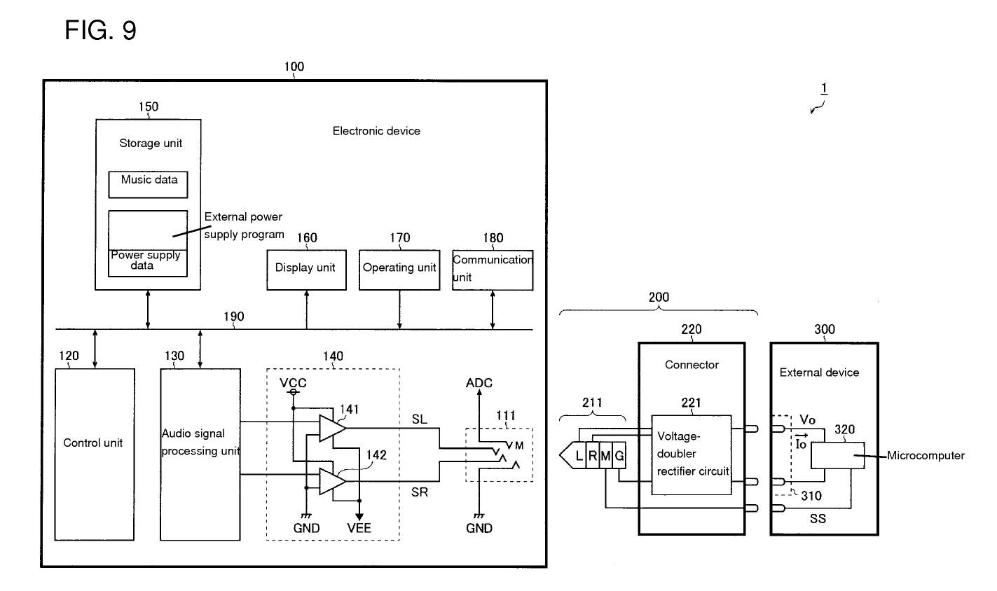

FIG. 9 is a block diagram showing a power supply system according to a third preferred embodiment of the present invention. The power supply system 1 of the third preferred embodiment basically has the same configuration as in the first preferred embodiment and is configured to perform a fully automatic function to set the supply voltage Vo. Therefore, constituent elements that are the same as in the first preferred embodiment will be given the same symbols as in FIG. 1, and redundant descriptions will be omitted. A description will be given below focusing only on portions that are characteristic of the third preferred embodiment.

In the power supply system 1 of the third preferred embodiment, the electronic device 100 includes a 4-pole external audio input/output terminal 111 which adds an M-pole terminal for microphone signal input, instead of the 3-pole external audio output terminal 110. Furthermore, in keeping with the change, the cable 200 also includes a 4-pole first connector 211 which adds an M-pole terminal for microphone signal output, instead of the 3-pole first connector 210.

Generally, a voice call headset or the like equipped with a headphone and a microphone is connected to or disconnected from the external audio input/output terminal 111 of the electronic device 100, but in the power supply system 1 of the third preferred embodiment, a function that fully automates the setting of the supply voltage Vo is implemented by using the 3 poles (L pole, R pole, and G pole) of signal output terminals out of the 4-pole terminal included in the external audio input/output terminal 111 as the power supply terminal to the external device 300 as well, the same as in the first preferred embodiment, and also by using the M-pole terminal for microphone signal input that is newly added as the start confirmation terminal of the external device 300 as well. Note that in order to realize this function, the M-pole terminal for microphone signal output installed in the first connector 211 is connected to the signal output terminal (the signal output port or the like of a microcomputer 320) in order to output a start confirmation signal SS from the external device 300.

The M-pole terminal of the external audio input/output terminal 111 is connected to the controller 120 over an analog/digital (A/D) converter (not shown). The controller 120 recognizes the input to the M-pole terminal as a microphone signal when in the external audio output mode, while also recognizing the same input as a start confirmation signal SS when in the external power supply mode. Note that the start confirmation signal SS is, for example, a digital signal that is maintained at a low level until the external device 300 starts up and then rises to a high level at a point when the external device 300 is started up. Fundamentally, the A/D converter is designed so as to receive the input of an analog signal; there is no particular hindrance as long as the pulse level of the start confirmation signal SS is contained within the input dynamic range.

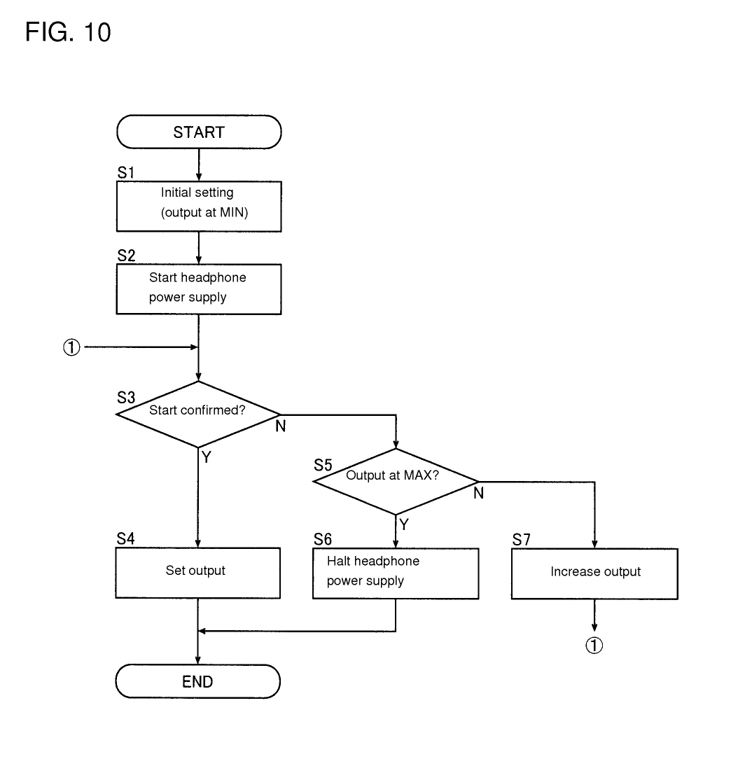

FIG. 10 is a flowchart for illustrating the operation for fully automated setting of the supply voltage Vo. This procedure starts when the external power supply program is executed and the headphone power supply mode is turned on. When the procedure starts, the target value for the supply voltage Vo (and consequently the amplitude of supply voltages SL and SR) is set in step S1 to its initial value (=the minimum value MIN of the adjustable range), and subsequently, in step S2, external power supply using the external audio input/output terminal 111 (here, abbreviated as “headphone power supply” for explanatory convenience) begins. The details of the headphone power supply operation in this step S2 are as described previously, so redundant explanation will be omitted.

Afterward, in step S3, a determination is made as to whether or not startup of the external device 300 has been confirmed (in concrete terms, whether or not the start confirmation signal SS has risen to a high level). If the result here is Yes, the procedure advances to step S4; if the result is No, the procedure advances to step S5.

If the result of step S3 is No, then in step S5, a determination is made as to whether or not the target value for the supply voltage Vo set at this point is the maximum value MAX of the adjustable range. If the result here is Yes, the procedure advances to step S6; if the result is No, the procedure advances to step S7.

If the result of step S5 is No, then in step S7, the target value of the supply voltage Vo is increased by one level, after which the procedure returns to step S3. The procedure thereafter loops through step S3, step S5, and step S7, gradually increasing the target value of the supply voltage Vo, until the result of step S3 or step S5 is Yes.

If the result of step S3 is Yes, then in step S4, the target value for the supply voltage Vo set at this point is established as the target value for the final supply voltage Vo, after which a series of procedure terminates.

On the other hand, if the result of step S5 is Yes without the result in step S3 having been Yes, then in step S6, headphone power supply is halted, and the procedure then terminates. For example, when ordinary headphones or an ordinary headset is mistakenly connected to the external audio input/output terminal 111 despite the headphone power supply mode being on, a start confirmation signal SS will never be detected even if the target value of the supply voltage Vo is raised to the maximum value MAX. In this case, the result of step S5 will be Yes, so any unnecessary headphone power supply operation can be promptly halted.

As was described above, in the power supply system 1 of the third preferred embodiment, the electronic device 100 gradually raises the amplitudes of the power-supply signals SL and SR, and when it detects a start confirmation signal SS that is input at the external audio input/output terminal 111 over the cable 200 from the external device 300, it halts the increase in the amplitudes of the power-supply signals SL and SR and sets the amplitudes of the power-supply signals SL and SR. By using such a configuration, a supply voltage Vo appropriate to the external device 300 is adjusted automatically.

### Fourth Preferred Embodiment

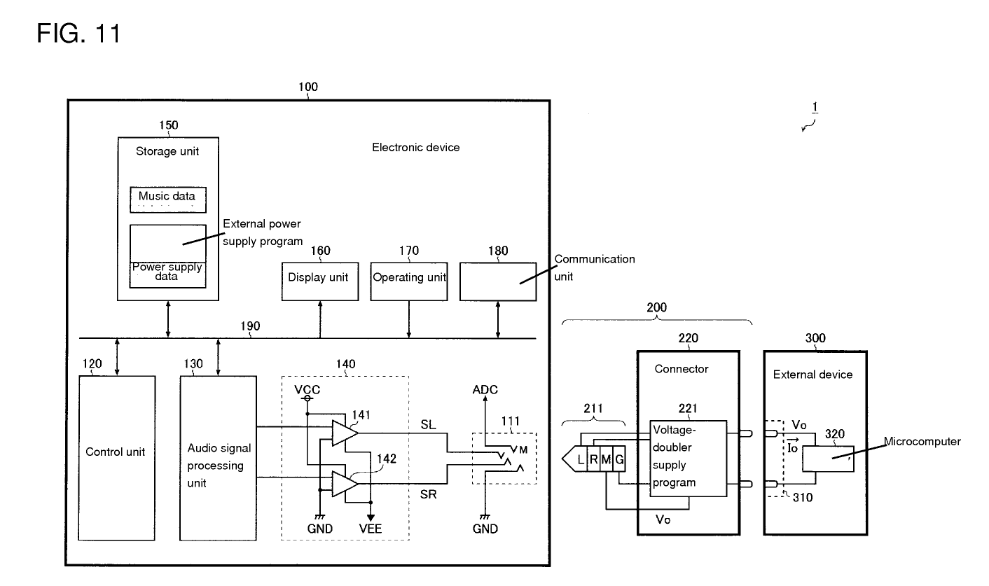

FIG. 11 is a block diagram showing a power supply system according to a fourth preferred embodiment of the present invention. The power supply system 1 of the fourth preferred embodiment basically has the same configuration as in the third preferred embodiment and is configured to perform an output feedback control function for the supply voltage Vo instead of the fully automatic setting function for the supply voltage Vo. Therefore, constituent elements that are the same as in the third preferred embodiment will be given the same symbols as in FIG. 9, and redundant descriptions will be omitted. A description will be given below focusing only on portions that are characteristic of the fourth preferred embodiment.

In the power supply system 1 of the fourth preferred embodiment, the supply voltage Vo generated by the voltage-doubler rectifier circuit 221 is applied to the M-pole terminal for microphone signal output installed in the first connector 211, rather than the start confirmation signal SS of the external device 300.

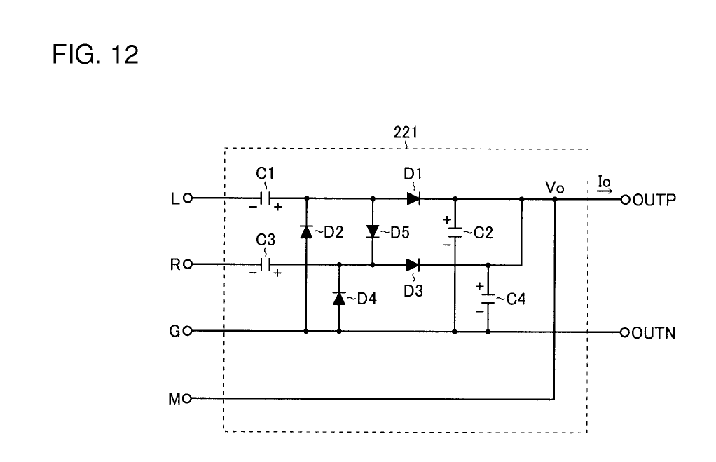

FIG. 12 is a circuit diagram showing a third configuration example of the voltage-doubler rectifier circuit 221. The voltage-doubler rectifier circuit 221 of the third configuration example has basically the same configuration as the first configuration example (see FIG. 3) and is configured such that the supply voltage Vo is applied to both the positive output terminal OUTP and the feedback output terminal M (the M-pole terminal of the first connector 210).

The controller 120 recognizes the input to the M-pole terminal as a microphone signal when in external audio output mode, while also recognizing the same input as the feedback signal of the supply voltage Vo (measured value) when in external power supply mode. The controller 120 then adjusts the amplitude of the power supply signals SL and SR such that the measured value and the target value of the supply voltage Vo match.

As was described above, in the power supply system 1 of the fourth preferred embodiment, the electronic device 100 adjusts the amplitude of the power-supply signals SL and SR such that the supply voltage Vo fed back as input to the external audio input/output terminal 111 over the cable 200 from the rectifier circuit 221 matches a target value. By adopting such a configuration, the voltage Vo supplied to the external device 300 is matched to a target value with good precision.

### Other Modified Examples

Note that besides the preferred embodiments described above, a variety of modifications can be made to the various technological characteristic features disclosed in this specification within the scope that does not depart from the spirit of the technological creations thereof. That is, the preferred embodiments merely constitute illustrative examples in all respects and should be considered to be non-restrictive. The technological scope of the present invention is indicated not by the description of the preferred embodiments but rather by the scope of the claims, and it should be understood that all modifications and equivalents are included within the scope of the claims are included.

Preferred embodiments of the present invention are applicable to electronic devices in general that are equipped with an external audio output terminal.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A power supply system comprising:
an electronic device configured to output from an external audio output terminal a power-supply signal according to a target value for a supply voltage when power is supplied to an external device; and
a cable including a rectifier circuit configured to rectify the power-supply signal and generate the supply voltage.

2. The power supply system according to claim 1, wherein the electronic device is configured to output sine wave signals on two channels of different phases as the power-supply signals, and the rectifier circuit is configured to double a voltage, through rectification, of each of the two channels of power-supply signals and combine the power-supply signals to generate the supply voltage.

3. The power supply system according to claim 1, wherein the electronic device is configured to output sine wave signals on two channels as the power-supply signals, and the rectifier circuit is configured to double a voltage, through rectification, of each of the two channels of power-supply signals to generate two circuits of supply voltages in parallel.

4. The power supply system according to claim 1, wherein the electronic device is configured to increase an amplitude of the power-supply signal, and when the electronic device detects a start confirmation signal that is input at the external audio input terminal over the cable from the external device, the electronic device halts the increase in the amplitude of the power-supply signal and sets the amplitude of the power-supply signal.

5. The power supply system according to claim 1, wherein the electronic device is configured to adjust an amplitude of the power-supply signal such that the supply voltage fed back to the external audio input terminal over the cable from the rectifier circuit matches a target value.

6. The power supply system according to claim 1, wherein the electronic device is one of a phone, a computer, and an electronic game unit.

7. The power supply system according to claim 1, wherein the rectifier circuit is a voltage doubler rectifier circuit.

8. The power supply system according to claim 7, wherein the voltage doubler rectifier circuit includes a plurality of capacitors and a plurality of diodes.

9. The power supply system according to claim 8, wherein the capacitors and the diodes are stacked in pairs serially in multiple levels.

10. The power supply system according to claim 1, wherein the rectifier circuit is a full-wave rectifier circuit.

11. The power supply system according to claim 1, wherein the cable includes first and second connectors.

12. The power supply system according to claim 11, wherein the cable includes a first connector and two-circuit second connectors.

13. The power supply system according to claim 1, wherein the rectifier circuit includes two-circuit voltage-doubler rectifier circuits.

14. The power supply system according to claim 1, wherein the external audio output terminal is one of a 3-pole external audio output terminal and a 4-pole external audio output terminal.

15. An electronic device comprising:
an external audio output terminal; and
a controller configured and programmed to control switching between an external audio output mode which outputs an audio signal from the external audio output terminal and an external power supply mode which outputs a power-supply signal from the external audio output terminal.

16. The power supply system according to claim 15, wherein the electronic device is one of a phone, a computer, and an electronic game unit.

17. The power supply system according to claim 15, wherein the controller is configured and programmed to:
control signal output from the external audio output terminal such that an audio signal is output according to audio data when in the external audio output mode; and
control signal output from the external audio output terminal such that a power-supply signal is output according to a target value for supply voltage to the external device when in the external power supply mode.

18. A cable comprising:
a first connector that is configured to be connected to or disconnected from an external audio output terminal of an electronic device which defines a power-supplying side;
a second connector that is configured to be connected to or disconnected from a power supply terminal of an external device which defines a power-receiving side; and
a rectifier circuit configured to generate a supply voltage to the external device by rectifying a power-supply signal that is output from the external audio output terminal of the electronic device.

19. A non-transitory computer-readable medium including a program for performing, when the program runs on a controller of an electronic device including an external audio output terminal in order to supply power from the electronic device to an external device over a cable with a rectifier circuit, a method comprising the steps of:
switching between an external audio output mode and an external power supply mode;
controlling signal output from the external audio output terminal such that an audio signal is output according to audio data when in the external audio output mode; and
controlling signal output from the external audio output terminal such that a power-supply signal is output according to a target value for supply voltage to the external device when in the external power supply mode.
